(19) United States
(12) Patent Application Publication
(10) Pub. No.: US 2008/0223769 A1
(43) Pub. Date: Sep. 18, 2008

(54) Method of singulating articles in a transport system

(75) Inventor: Klaus Koenig, Reichenau (DE)

Correspondence Address: SIEMENS SCHWEIZ AG;I-47, INTELLECTUAL PROPERTY, ALBISRIEDERSTRASSE 245, ZURICH, CH-8047, CH

(73) Assignee: SIEMENS AKTIENGESELLSCHAFT, MUNICH (DE)

(21) Appl. No.: 11/724,392

(22) Filed: Mar. 15, 2007

(51) Int. Cl. B07C 5/00

(52) U.S. Cl. 209/555

(57) ABSTRACT

In a method of singulating pockets in a mail processing system to extract mail items from the pockets, a first guide is provided within an extraction are. A second guide carrying a predetermined number of pockets is coupled to the first guide, wherein the pockets are arranged in series on the second guide, and wherein each pocket contains at least one mail item between two lateral walls. The first guide and the second guide are moved at a predetermined constant velocity. At least one pocket located on the second guide closest to the first guide is transferred from the second guide to the first guide. Within the extraction area, an extraction device is engaged with the pocket transferred to the first guide to extract the at least one mail item from that pocket.

### BACKGROUND OF THE INVENTION

The various embodiments described herein relate generally to the field of processing objects. More particularly, these embodiments relate to a method of singulating objects in a transport system.

One example of a transport system is used in connection with a mail processing system. Each day postal services process mail items for delivery to millions of individual domestic addresses. As used throughout this application, mail items refer to letters, magazines, books and other such flat items. Before mail carriers begin to walk through or drive through their delivery routes, a mail processing system at a processing site sorts all mail items for the carriers and prepares the sorted mail items for delivery to a multitude of domestic addresses. A carrier's responsibility includes putting all of these mail items into an appropriate sequence for efficient delivery to the domestic addresses.

The mail processing system is highly automated to handle the amount of daily mail items. Some mail processing systems may include a delivery point packaging (DPP) system that, for example, separates the mail items, reads their destination addresses and groups the mail items based upon their respective destination addresses. U.S. Pub. No. 2003/0038065 describes an automated DPP system that includes casing towers each carrying, on a given number of levels, vertically oriented pockets (slots) with front openings to receive mail items in horizontal direction. The pockets are grouped in containers or pods to receive most or all mail for the respective delivery point. Robots travel on a transport system and transport the mail items to the pockets, one mail item per robot, and insert them into the pockets. Each robot is equipped with an inserter apparatus configured to extend towards the pocket to insert the mail item into the assigned pocket. After the mail item is inserted, the inserter apparatus retracts and the empty robot returns to a loading station.

In the system according to U.S. Pub. No. 2003/0038065, extraction of the one or more mail items from the pockets occurs in opposite direction to the loading direction, i.e., horizontally through the front opening. Further, extraction occurs while the pockets are arranged side by side on the pods, which may not be ideal for further processing the pockets, i.e., extracting the mail items from the pockets. Each pocket includes a mechanism that transports the one or more mail items horizontally out of the pocket. This mechanism includes a belt system with a bridge (H-belt) that pushes the mail items out of the pocket. The pocket is, therefore, a complex structure.

### SUMMARY OF CERTAIN INVENTIVE ASPECTS

A general aspect of a transport system, such as a mail processing system or the like, is to operate as efficient and reliable as possible and as inexpensive as possible. One parameter that influences efficiency, reliability, and operating costs is how the objects to be processed are handled by the transport systems in preparation for the further processing. In the above described mail processing system, for example, the process of extracting the mail items, in particular how long it takes to empty a pocket, is such a determinative parameter. There is, therefore, a need for an improved technique for handling objects in a transport system. Accordingly, the various embodiments described herein provide for such an improved technique in that the objects are singulated for further processing, i.e., even though the objects are arranged on a carrier side by side (e.g., the pockets on a pod), for further processing the objects are separated from each other.

Accordingly, one aspect involves a method of singulating objects in a transport system. A first guide is provided within a processing area. A second guide carrying a predetermined number of objects is coupled to the first guide, wherein the objects are arranged side by side on the second guide. The first guide and the second guide are moved at a predetermined constant velocity. The at least one object located on the second guide closest to the first guide is transferred from the second guide to the first guide. Within a processing area, the object transferred to the first guide is processed.

Another aspect involves a method of singulating pockets in a mail processing system to extract mail items from the pocket. According to this method, a first guide is provided within an extraction are. A second guide carrying a predetermined number of pockets is coupled to the first guide, wherein the pockets are arranged in series on the second guide, and wherein each pocket contains at least one mail item between two lateral walls. The first guide and the second guide are moved at a predetermined constant velocity. At least one pocket located on the second guide closest to the first guide is transferred from the second guide to the first guide. Within the extraction area, an extraction device is engaged with the pocket transferred to the first guide to extract the at least one mail item from that pocket.

Advantageously, the guides that carry the objects (pockets) move continuously through the processing area, even if the objects need to be stopped for processing, for example, emptying the pockets, or need to be moved with a different velocity. The complexity of the transport system as to its control and mechanical structure is, thereby, relatively low.

### BRIEF DESCRIPTION OF THE DRAWINGS

These and other aspects, advantages and novel features of the embodiments described herein will become apparent upon reading the following detailed description and upon reference to the accompanying drawings. In the drawings, same elements have the same reference numerals. In the following list of figures:

FIG. 1 depicts a schematic illustration of one embodiment of an arrangement of guides and pockets of a mail processing system; and

FIGS. 2a-2g depict various stages of one embodiment of an extraction process.

### DETAILED DESCRIPTION OF CERTAIN INVENTIVE EMBODIMENTS

The following detailed description occurs with reference to a transport system as used in a mail processing system. However, a mail processing system is considered to be only one example of an application, where objects are singulated to facilitate further processing, for example, extraction of mail items contained in pockets. It is contemplated that the method described herein is applicable any system, where objects need to be separated from each other for processing, such as in assembly lines that transport objects together, but process the objects individually.

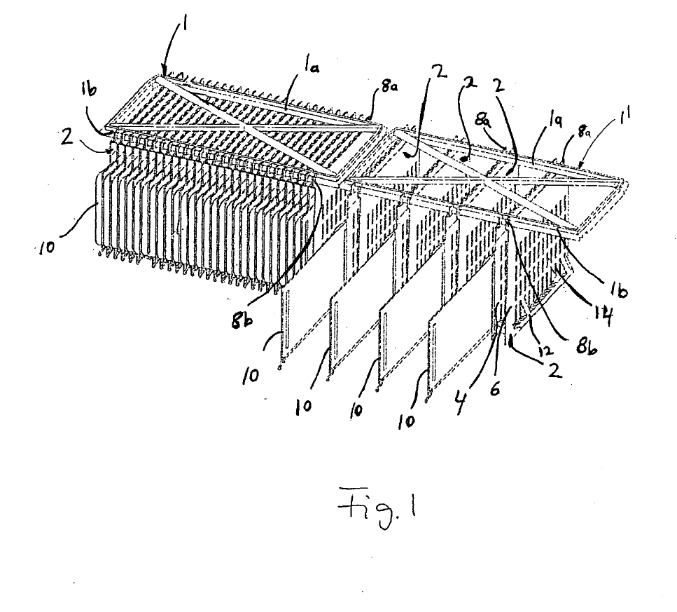

FIG. 1 shows a schematic illustration of one exemplary embodiment of an arrangement of two guides 1, 1′ and pockets 2. Each guide 1, 1′ carries a plurality of pockets 2, and may be referred to as a pod. In FIG. 1, the guide 1 is configured to carry, for example, between about 10 and about 30 filled pockets 2. The guide 1′ is shown as carrying four pockets 2. It is contemplated that the guide 1′ is initially empty and successively receives pockets 2 from the guide 1, as described below in more detail. Each pocket 2 represents, for example, an individual destination address of a mail recipient. However, it is contemplated that the pocket 2 may be filled according to other criteria, such as post codes or addressee names.

The pocket 2 is configured to contain at least one mail item between two lateral walls 4, 6. The lateral walls 4, 6 have support elements 8a, 8b to secure the pocket 2 to rails 1a, 1b of the guide 1, 1′. The support elements 8a, 8b allow the lateral walls 4, 6 to move along the rails 1a, 1b, and with respect to each other. This allows a pocket 2 to expand in direction of the rails 1a, 1b, i.e., to “breath” depending on the number of mail items contained in the pocket 2. That is, the pocket 2 widens as a function of the number of mail items loaded to the pocket 2 via an open front side. In one embodiment, the pocket 2 is loaded using a slip sheet 10 similar to the loading described in the above mentioned U.S. Pub. No. 2003/0038065. In FIG. 1, the slip sheet 10 is shown as being introduced into the pockets 2 of the guide 1, but as withdrawn from the pockets 2 of the guide 1′.

Each lateral wall 4, 6 has at least one opening 14. In the illustrated embodiment, each lateral wall 4, 6 has vertical rows of individual openings 14, wherein each opening 14 has a rectangular shape. The number and size of the openings 14 is dependent on a particular kind of extraction device used to extract the at least one mail item from the pocket 2. One embodiment of an extraction device has support elements and contact elements provided on the support elements. The extraction device is configured to engage the lateral walls 4, 6 of the pocket 2 so that the contact elements extend through the openings 14 and urge the at least one mail item away from inner surfaces of the lateral walls 4, 6. Once the extraction device is engaged, the contact elements cause the at least one mail item contained in the pocket 2 to pass through the bottom area 10 when in the open state.

The contact elements are driven to exert a downward force on the mail item to overcome any frictional force between the mail item and the neighboring lateral walls 4, 6. When the extraction device is engaged, the contact elements first urge any curved or bent mail item away from the lateral walls 4; the exerted downward force then urges the mail item downwards. Hence, the extraction device ensures that even curved or bent mail items, which might otherwise get stuck between the lateral walls 4, 6, are extracted from the pocket 2. Further details of the extraction device are described in concurrently filed US application entitled METHOD AND SYSTEM FOR EXTRACTING SORTED MAIL ITEMS IN MAIL PROCESSING SYSTEMS, which names as inventors Klaus Koenig and Peter Enekel, the whole disclosure of which is hereby incorporated by reference.

The pocket 2 includes further a release mechanism 12 at a bottom area that is configured to place the bottom area in an open state and a closed state. The release mechanism 12 can be configured, for example, similar to a trap door mechanism, or similar to a drawer mechanism. Referring to the first pocket 2 on the guide 1′ shown in the embodiment of FIG. 1, the release mechanism 12 is visible at the open front side and the lateral wall 6 in proximity of the bottom area. Once the release mechanism 12 places the bottom area in the open state, the mail item falls through the open bottom area in a container or onto a conveyor belt for further processing. The release mechanism 12 is described in greater detail in the above incorporated concurrently filed US application entitled METHOD AND SYSTEM FOR EXTRACTING SORTED MAIL ITEMS IN MAIL PROCESSING SYSTEMS.

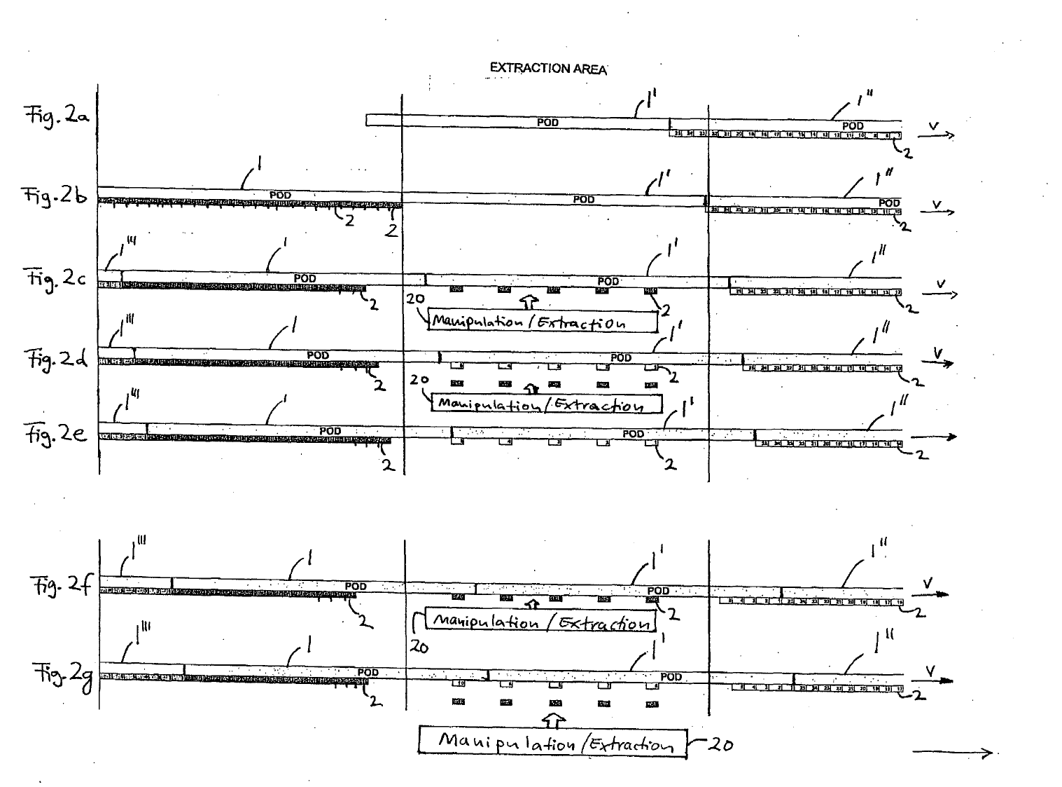

FIGS. 2a-2g depict various stages of one embodiment of a process used to extract the mail items from the pockets 2. The process is described with reference to the guides 1, 1′ shown in FIG. 1 and schematically illustrated and labeled in FIGS. 2b-2g as PODs. The guide 1 carries 25 filled pockets 2. These figures show further guides 1″, 1′″, and illustrate a scenario in which, from left to right, the guide 1 arrives at an extraction area, the pockets 2 are successively transferred to the neighboring guide 1′ and emptied in the extraction area, and the guide 1′ departs from the extraction area. The departing guide 1′ carries only empty pockets 2.

The extraction area includes a manipulating system 20 and an extraction device. The extraction device may be incorporated in the manipulation system 20. During the illustrated process, the guides 1-1′″ move with a constant velocity from left to right. In one embodiment, the guides 1-1′″ are coupled to a transport system that moves the guides 1-1′″. In FIGS. 2a-2g, an arrow V indicates the movement of the guides 1-1′″.

In FIG. 2a, the empty guide 1′ is shown as moving into the extraction area. The guide 1′ is coupled to a guide 1″, which is shown as moving out of the extraction area. The guide 1″ carries 25 empty pockets 2. For ease of illustration, only a few pockets 2 are shown on the guide 1″.

In FIG. 2b, the arriving guide 1 is coupled to the guide 1′ and about to enter the extraction area. The guide 1′ is further coupled to the guide 1″, and the manipulating system 20 is inactive. For example, the manipulating system 20 may be retracted.

In FIG. 2c, the first five pockets 2 of the guide 1 are transferred to the guide 1′. In one embodiment, the manipulating system 20 is configured to extend towards the pockets 2 of the guide 1, to successively grab a pocket 2 and to transfer it to the guide 1′. The manipulating system 20 is configured to separate (singulate) the pockets 2 from each other. In one embodiment, the five pockets 2 may be equally spaced. The distance between the pockets 2 is selected to allow individual handling of a pocket 2, for example, so that the extraction device can engage a pocket 2. Further, FIG. 2c shows that the next guide 1′″ arrives and couples to the guide 1.

In FIG. 2d, the five pockets 2 on the guide 1′ are emptied, for example, by extraction devices, each engaging the lateral walls 4, 6 of a pocket 2. Once an extraction device is engaged, the pocket's release mechanism 12 opens the bottom area of the pocket 2, and the extraction device is activated to cause the at least one mail item to drop into a container, or onto a conveyor belt. In FIG. 2e, the five pockets 2 on the guide 1′ are empty.

FIG. 2f illustrates a more advanced stage of the process, in which the now empty first five pockets 2 are positioned next to each other on the guide 1′, and the next five pockets 2 of the guide 1 are already transferred to the guide 1′. In one embodiment, the manipulating system 20 is further configured to move the empty pockets 2 to the right side of the guide 1′, for example, by pushing them to the right side.

In FIG. 2g, the pockets 2 on the guide 1′ are emptied by the extraction device, as described above with reference to FIG. 2d.

The above-described process continues until all pockets 2 on the guide 1 are emptied and transferred to the guide 1′. It is contemplated that a new (empty) guide 1′ is supplied as soon as the current guide 1′ is completely loaded with empty pockets 2.

As mentioned above and indicated by the arrow V, the guides 1-1′″ move with a constant velocity from left to right. Outside the extraction area, the pockets 2 move with the same velocity as the guides 1-1′″. Within the extraction area, the pockets 2 are singulated, as shown, for example, in FIG. 2c, and move at least temporarily with a higher velocity. Depending on a particular embodiment of the process described with reference to FIGS. 2a-2g, within the extraction area the pockets 2 may be accelerated or stopped for a predetermined period of time. Once the pockets 2 within the extraction area are emptied, the velocity of these pockets 2 is synchronized with the velocity of the (empty) guide 1′ so that the empty pockets 2 move again with the same velocity as the guides 1-1′″.

In the embodiment shown in FIGS. 2a-2g, the pockets 2 are handled in groups of five. However, it is contemplated that the pockets 2 may be handled in smaller or larger groups.

The manipulating system 20 is configured to operate according to one of several options. According to a first option, a group of N pockets 2 (e.g., N=5, as in embodiment illustrated in FIGS. 2a-2g) is processed in a non-continuous mode to singulate the N pockets 2. As soon as the pockets 2 have a predetermined distance to each other, the pockets 2 are stopped. In one embodiment, instead of waiting until the pockets 2 reach the predetermined distance to each other, the extraction device is configured to recognize the position and orientation of a pocket 2.

Once the pockets 2 are stopped, they are stationary within the extraction area and, depending on a desired complexity, one or more extraction devices may engage the pockets 2. The embodiment illustrated in FIGS. 2a-2g shows that, while the guide 1′ continues to move, the pockets 2 are stationary within the extraction area during the extraction process. The emptied pockets 2 are pushed together towards the right side of the guide 1′. This process is repeated until all pockets 2 of the guide 1 are emptied and moved to the guide 1′.

According to a second option, a group of N pockets 2 (e.g., N=5) is processed in a continuous mode to singulate the pockets 2. As soon as the pockets 2 have a predetermined constant distance to each other, the pockets 2 are transported at a constant velocity. While the pockets 2 move, a synchronously moving extraction system is activated to empty the pockets 2. In one embodiment, the synchronously moving extraction system is part of the manipulating system 20. Once the pockets 2 are emptied, the extraction system is retracted. The emptied pockets 2 are pushed together towards the right side of the guide 1′. This process is repeated until all pockets 2 of the guide 1 are emptied and moved to the guide 1′.

In the embodiments according to the first and second options, as the number of pockets 2 in a group and the constant velocity of the pockets 2 are known, the pockets 2 are transported to the same locations within the extraction area. Advantageously, this simplifies the control of the process.

According to a third option, the pockets 2 are singulated individually in a non-continuous mode. Once the guide 1 couples to the guide 1′, the first pocket 2 is accelerated to a velocity that is higher than that of the guides 1, 1′, which singulates that pocket 2 from the other loaded pockets 2, and transfers the pocket to a predetermined position, where it remains stationary. A stationary extraction device empties the pocket 2. The empty pocket 2 is then transferred to the right side of the guide 1′. This process is repeated until all pockets 2 of the guide 1 are emptied and moved to the guide 1′.

According to a fourth option, the pockets 2 are singulated individually in a continuous mode. Once the guide 1 couples to the guide 1′, the first pocket 2 is accelerated to a velocity that is higher than that of the guides 1, 1′, which singulates that pocket 2 from the other loaded pockets 2, and transfers the pocket to a predetermined position. While the pocket 2 continues to move, a synchronously moving extraction system is activated to empty the pocket 2. Once the pocket 2 is emptied, the extraction system retracts. This process is repeated until all pockets 2 of the guide 1 are emptied and moved to the guide 1′.

It is apparent that there has been disclosed a method for singulating objects, such as pockets in a mail processing system, that fully satisfies the objects, means, and advantages set forth hereinbefore. For example, the method allows maintaining the complexity of the transport system low since the guides are move at a constant velocity, even if the velocity of the pockets needs to be changed within the processing area, e.g., the pockets need to be stopped to allow the extraction device to engage the pockets.

1. A method of singulating pockets in a mail processing system to extract mail items from the pockets, comprising:
providing a first guide within an extraction area;
coupling a second guide carrying a predetermined number of pockets to the first guide, wherein the pockets are arranged in series on the second guide, and wherein each pocket contains at least one mail item between two lateral walls;
moving the first guide and the second guide at a predetermined constant velocity;
transferring at least one pocket located on the second guide closest to the first guide from the second guide to the first guide; and
within the extraction area, engaging an extraction system with the pocket transferred to the first guide to extract the at least one mail item from that pocket during an extraction process.

2. The method of claim 1, further comprising accelerating the pocket to a velocity that is higher than the predetermined velocity while transferring the pocket to the first guide so that the pocket is singulated on the first guide.

3. The method of claim 2, further comprising stopping the pocket on the first guide, while the first guide continues to move so that the pocket remains stationary within the extraction area during the extraction process.

4. The method of claim 2, further comprising decelerating the pocket to the predetermined velocity and moving the extraction system at the predetermined constant velocity so that the extraction system and the pocket move within the extraction area during the extraction process at the predetermined velocity.

5. The method of claim 1, further comprising defining a group containing a predetermined number of pockets, wherein said transferring includes transferring the predetermined number of pockets to the first guide and spacing the pockets at a predetermined distance from each other.

6. The method of claim 5, further comprising stopping the pockets on the first guide, while the first guide continues to move so that the pockets remain stationary within the extraction area during the extraction process.

7. The method of claim 5, further comprising moving the extraction system at the predetermined constant velocity so that the extraction system and pockets move within the extraction area during the extraction process.

8. A method of singulating objects in a transport system, comprising:
providing a first guide within a processing area;
coupling a second guide carrying a predetermined number of objects to the first guide, wherein the objects are arranged side by side on the second guide;
moving the first guide and the second guide at a predetermined constant velocity;
transferring at least one object located on the second guide closest to the first guide from the second guide to the first guide; and
within a processing area, processing the object transferred to the first guide.

9. The method of claim 8, further comprising accelerating the object to a velocity that is higher than the predetermined velocity while transferring the object to the first guide so that the object is singulated on the first guide.

10. The method of claim 9, further comprising stopping the object on the first guide, while the first guide continues to move so that the object remains stationary within the processing area during processing.

11. The method of claim 9, further comprising decelerating the object to the predetermined velocity and moving a processing system at the predetermined constant velocity so that the processing system and the object move within the processing area during the processing at the predetermined velocity.

12. The method of claim 8, further comprising defining a group containing a predetermined number of objects, wherein said transferring includes transferring the predetermined number of objects to the first guide and spacing the objects at a predetermined distance from each other.

13. The method of claim 12, further comprising stopping the objects on the first guide, while the first guide continues to move so that the objects remain stationary within the processing area during the processing.

14. The method of claim 12, further comprising moving a processing system at the predetermined constant velocity so that the processing system and pockets move within the processing area during the processing.
